(19) United States
(12) Patent Application Publication
(10) Pub. No.: US 2002/0154884 A1
(43) Pub. Date: Oct. 24, 2002

(54) Method for controlling electron stream within lamp of cold cathode fluorescent tube, method for driving cold cathode fluorescent tube type illumination device using the same, cold cathode fluorescent tube type illumination device and LCD having the same

(75) Inventor: In-Sun Hwang, Suwon-si (KR)

Correspondence Address: McGuire Woods, Suite 1800, 1750 Tysons Boulevard, McLean, VA, 22102-4215, US

(73) Assignee: Samsung Electronics Co., LTD.

(21) Appl. No.: 10/093,403

(22) Filed: Mar. 11, 2002

(30) Foreign Application Priority Data
Mar. 12, 2001 (KR) 2001-12673

(51) Int. Cl. G02B 6/10

(52) U.S. Cl. 385/146

(57) ABSTRACT

There is disclosed a CCFT type illumination device having low driving voltage and low power consumption characteristics, a driving method of the illumination device and an LCD adopting the driving method and the illumination device. A first driving voltage having a first polarity is applied between a first electrode and a second electrode facing the first electrode such that a potential difference is generated between the electrodes. The polarity of the first and second electrodes is inverted within an electron annihilation time when electrons within the tube of the lamp move from the first electrode to the second electrode and are annihilated. A second driving voltage with an opposite polarity to the first polarity is then applied between the electrodes. Longer-length lamps are made feasible.

### BACKGROUND OF THE INVENTION

1. Field of the Invention

The present invention relates to a method for controlling an electron stream within a lamp of a cold cathode fluorescent tube (CCFT), a CCFT illumination device, a method for driving the CCFT illumination device using the controlling method and a liquid crystal display (LCD) having the CCFT illumination device. More particularly, the present invention relates to a method for controlling an electron stream within a lamp of a CCFT, the method allowing a long cold cathode ray tube type illumination device to operate at a comparatively low start voltage by altering the electron stream within the lamp or the operation method of the lamp, an LCD to have a large screen size and a low power consumption due to the low start voltage. Further, the invention relates to a CCFT tube illumination device and a method for driving the CCFT illumination device using the controlling method and an LCD having the CCFT illumination device

2. Description of the Related Art

Generally, CCFT illumination devices, for example, home illumination devices, light supplying devices for LCDs, copiers, scanners, etc., are widely used in various products that need a linear light source. The CCFT illumination devices have advantages in that the amount of emitted heat is small and the life and frequent turning on and off-resistant endurance are longer than heat radiation illumination devices such as an incandescent lamp, and they can be also manufactured to any length.

The CCFT illumination devices having the above advantages operate in a specific way As a high voltage is applied to two electrodes spaced apart by a selected distance, electrons spatially moved across two electrodes collide with mercury atoms in the lamp to thereby generate ultraviolet rays. The generated ultraviolet rays stimulate the fluorescent particles to thereby generate visible rays.

Thus, in order to generate visible rays, the CCFT illumination devices need a CCFT lamp in which a fluorescent material is deposited on the inner surface; a pair of electrodes are formed at both ends of the CCFT lamp; and including a transformer that elevates a low voltage (not going beyond a few volts to a few tens of volts) up to a high voltage of a few hundred volts to a few kilovolts that is sufficient for of transferring electrons.

The operation method using the aforementioned transformer provides various advantages while it also has the following drawbacks. A voltage necessary for the operation of the CCFT lamp is divided into a start voltage that is initially applied to the lamp and a driving voltage that is applied after the elapse of a certain amount of time. Specifically, the start voltage should be much higher than the driving voltage such that the lamp is activated initially. However, this high start voltage increases the number of secondary windings, resulting in an abrupt increase in power consumption.

The above problems are described in more detail with reference to the accompanying FIGS. 2 and 3.

When it is assumed that a first CCFT lamp Lₐ having a length of W1 and shown in FIG. 2 is shorter than a second CCFT lamp L_{b} having a length of W2 and shown in FIG. 3, a voltage V3 output from a transformer T2, of the second CCFT lamp L_{b} is larger than a voltage V2 output from a transformer T1 of the first CCFT lamp L_{a.} This is because as a length between a pair of electrodes in each of the first and second CCFT lamps Lₐ and L_{b} increases, a discharge voltage increases in proportion to the length increase.

Formula 1

V2=N2/N1

Specifically, in order to apply the voltage V2 to the first CCFT lamp Lₐ, the transformer T1 needs a first coil 10 having the number of windings, N1 and a secondary coil 20 having the number of windings, N2 as shown in above formula 1.

Formula 2

V3=N3/N1

In the meanwhile, in order to apply the voltage V3 to the second CCFT lamp L_{b}, the transformer T2 needs a first coil 30 having the number of windings N1, and a secondary coil 40 having the number of windings N3, as shown in above formula 2.

As aforementioned, since the voltage V3 is larger than the voltage V2, it is obvious that the windings number N3 of the secondary coil 40 in the transformer T2 for elevating the voltage V3 to be applied to the second CCFT lamp L_{b} should be greater than the windings number N2 of the secondary coil 20 in the transformer T1 for elevating the voltage V2 to be applied to the first CCFT lamp Lₐ. Here, the windings number of the first coil 10 in the transformer T1 is the same as that of the first coil 30 in the transformer T2.

Then, when the voltage V3 higher than the voltage V2 is applied to the second CCFT lamp L_{b}, power consumption increases too. Thus, the increased length of the CCFT lamp adversely affects power consumption.

More specifically, as shown in FIG. 1, if the LCD panel assembly 70 of the LCD 60 is made in a large screen size, a light supply area of the CCFT illumination device 80 correspondingly has to increase.

Then, when the light supply area of the CCFT illumination device increases in proportion to the increase in the length of the lamp, that is, from W1 to W2 (W2>W1), power consumption increases too. As a result, there occurs a drawback in that re-charging is needed too soon after charging once.

### SUMMARY OF THE INVENTION

Accordingly, it is an object of the present invention to provide a method for controlling an electron stream within a CCFT lamp capable of decreasing the power consumption of the CCFT lamp to a large degree.

It is another object of the present invention to provide a method for driving a CCFT lamp illumination device with low power consumption by altering a method for controlling a stream of electrons within the CCFT lamp.

It is further another object of the present invention to provide a CCFT illumination device operating at a low power consumption by altering a method for controlling an electron stream within the CCFT lamp.

It is still another object of the present invention to provide an LCD having a high degree of efficiency and which is longer in the charge maintenance time arriving at a discharge state from a charged state by altering a method for controlling a stream of electrons within the CCFT lamp.

To accomplish the above objects, there is provided a method for controlling a stream of electrons within a CCFT lamp. The method comprises the steps of: applying a first driving voltage having a first polarity between a first electrode and a second electrode facing the first electrode, both electrodes being formed within a tube of the CCFT lamp such that a potential difference is generated between the first electrode and the second electrode; inverting polarity of the first and second electrodes within an electron annihilation time when electrons within the tube move from the first electrode to the is second electrode (i.e., by the generated potential difference) and are annihilated; and applying a second driving voltage having a second polarity opposite to the polarity-inverted first polarity between the first electrode and the polarity-inverted second electrode.

According to another aspect of the present invention, there is provided a method for driving a CCFT illumination device. The method comprises the steps of: generating a first driving voltage swinging with a predetermined polarity inversion time; elevating the first driving voltage up to a second driving voltage having a level higher than the first driving voltage, the second driving voltage being a minimum voltage level for generating an electron stream; and applying the second driving voltage to the CCFT lamp.

According to still another aspect of the invention, there is provided a method for driving a CCFT illumination device. The method comprises the steps of: generating a wave form (such as a step pulse wave) which swings with a reference voltage and a first polarity inversion time and a swing wave which swings with a second polarity inversion time longer than the first polarity inversion time; selecting the wave form to elevate the reference voltage step pulse wave up to a first voltage which is a minimum voltage level necessary for generating a stream of electrons within the CCFT lamp and then applying the first voltage to the lamp for a predetermined time; and selecting the sine wave to elevate the reference voltage up to a second voltage which is a minimum voltage level necessary for generating the stream of the electrons within the CCFT lamp and then applying the second voltage to the lamp for a predetermined time.

According to still another aspect of the present invention, there is provided a CCFT illumination device comprising:

a CCFT lamp including a CCFT lamp tube having a cylindrical shape of a predetermined length, a first electrode formed at one end of the lamp tube and a second electrode formed at the other end and facing the first electrode;

a waveform generating part for generating a waveform (such as a step pulse wave form) which swings with a first reference voltage and a first polarity inversion time;

a sine wave generating part for generating a sine wave which swings with the reference voltage and a second polarity inversion time longer than the first polarity inversion time;

a signal selection part for selecting the step pulse waveform or the sine wave;

means for determining a waveform applying timing with which the signal selection part selects the step pulse waveform or the sine wave;

and means for amplifying either the step pulse waveform or the sine wave to a predetermined level.

According to yet still another aspect of the present invention, there is provided an LCD comprising: an LCD panel assembly which controls an alignment of liquid crystal molecules in response to an input video signal to display a picture; and a backlight assembly including a CCFT lamp, a pulse generating part for generating either a first signal of a step pulse waveform or a second signal of a sine waveform, a signal selection part selecting either the first signal or the second signal, a module for determining a waveform applying timing which the signal selection part selects the step pulse waveform or the sine wave, an inverter having a signal amplifying part for amplifying the first signal or the second signal as selected to a certain level to apply the amplified signal to the CCFT lamp, and means for diffusing tight beams generated from the CCFT lamp.

### BRIEF DESCRIPTION OF THE DRAWINGS

The above objects and other advantages of the present invention will become more apparent by describing in detail the preferred embodiments thereof with reference to the accompanying drawings, in which:

FIG. 1 is a diagram of an LCD having a conventional CCFT illumination device;

FIG. 2 is a schematic view of a CCFT lamp having a length of W1 in accordance with the conventional art;

FIG. 3 is a schematic view of a CCFT lamp having a length of W2 longer than W1 in accordance with the conventional art;

FIGS. 4 and 5 are waveforms of sine waves applied to a general CCFT lamp;

FIG. 6 is a block diagram of a CCFT illumination device in accordance with one preferred embodiment of the invention;

FIG. 7 is a diagram showing the electron stream within the lamp tube of the CCFT type illumination device in accordance with one preferred embodiment of the present invention;

FIG. 8 is a graph partially showing an AC voltage waveform generating the electron stream of FIG. 7;

FIG. 9 is a graph partially showing an AC voltage waveform generating the electron stream;

FIG. 10 is a diagram showing the electron stream within the lamp tube of the CCFT illumination device generated by the AC voltage waveform of FIG. 9; and

FIG. 11 is a block diagram showing an LCD provided with the CCFT illumination device in accordance with the present invention.

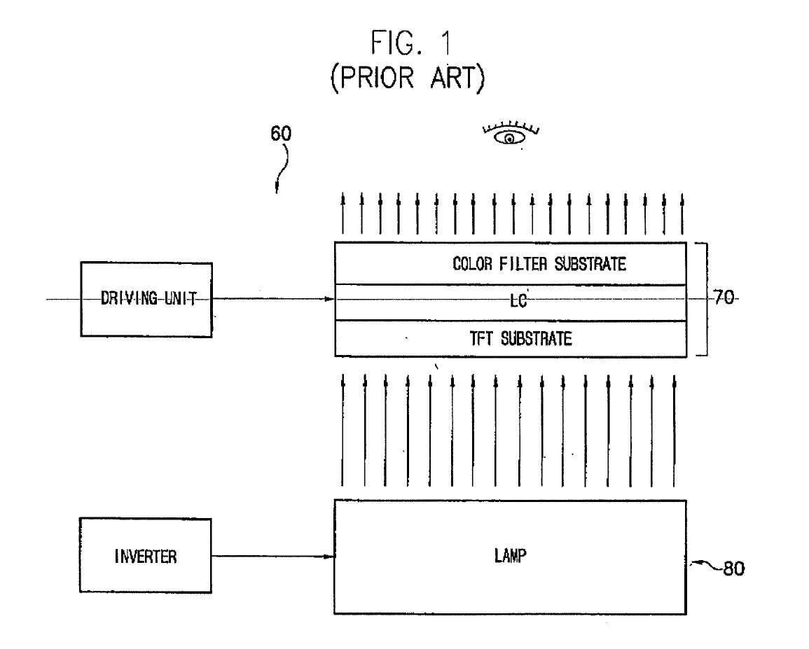

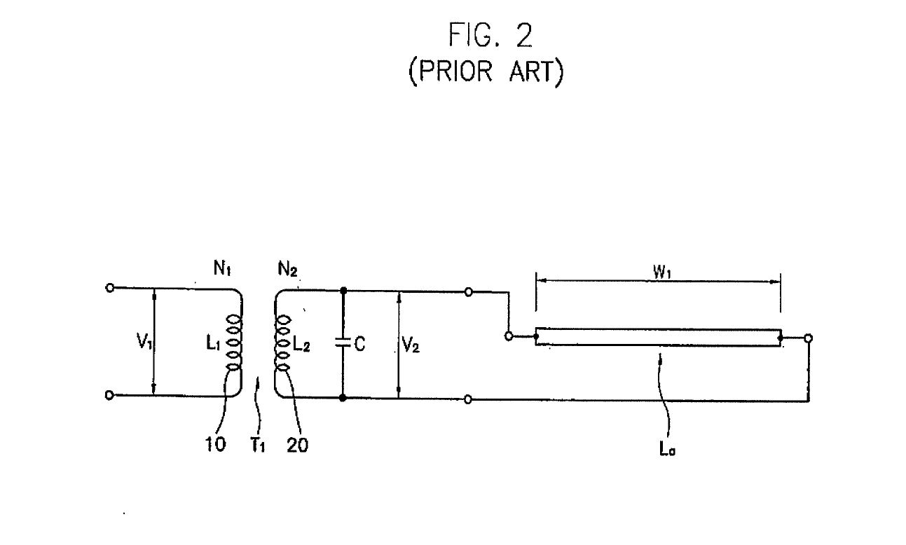

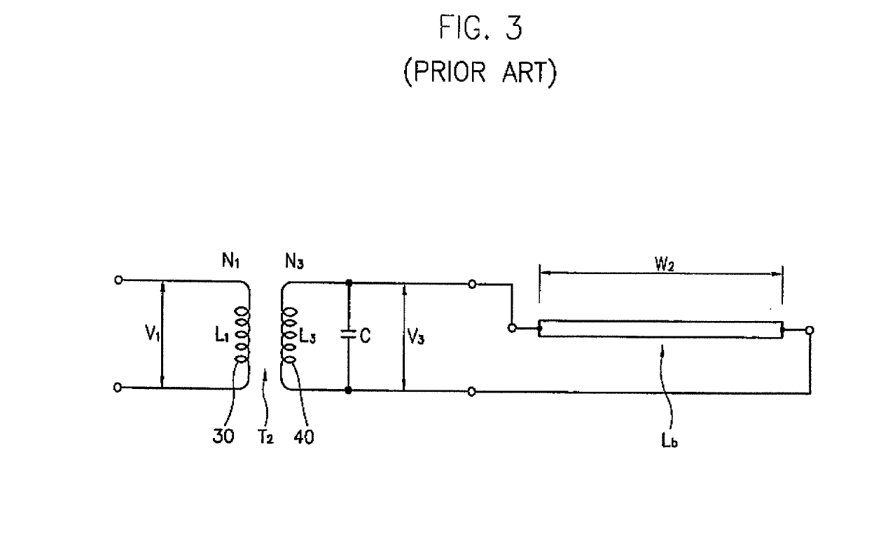

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein.

Prior to specifically describing embodiments of the present invention, there is described a method of decreasing a power consumption of a CCFT illumination device.

Specifically, the present invention controls an electron stream within a CCFT lamp as one embodiment to maximize density of the electrons within the lamp. A driving voltage is lowered and thereby power is saved.

An example includes two CCFT lamps of a first CCFT lamp and a second CCFT lamp. The first CCFT lamp has a first length and a first electron density and the second CCFT lamp has a second length that equals the first length of the first CCFT lamp and a second electron density that is higher than the first electron density of the first CCFT lamp.

The minimum driving voltage for turning on the first CCFT lamp is lower than the minimum driving voltage for turning on the second CCFT lamp. This means that as the electron density is higher, the minimum driving voltage and the power consumption are lowered, too.

Next, there is described a method of maximizing the electron density within a CCFT lamp.

In order to maximize the electron density within a CCFT lamp, a time spent in inverting the polarity of an AC driving voltage that is applied to a CCFT lamp should be considered. The time is set with reference to an electron annihilation time during which electrons generated from a cathode having negative (−) polarity arrive at, and disappear into, an anode having positive (+) polarity.

For example, when the disappearance time is assumed to be 5 μs, if the inverting time of the cathode and the anode is 5 μs and more, most of the electrons move into the anode, so that increasing the electron density within such a CCFT lamp is difficult.

Meanwhile, if the inverting time is 5 μs or less, electrons move into the electrode having the inverted positive polarity before part of the electrons completely move into the positive electrode due to a short inverting time, so that increasing the density of the electrons becomes possible.

This means that inverting of the polarity should be performed within a short time in order to maximize the electron density.

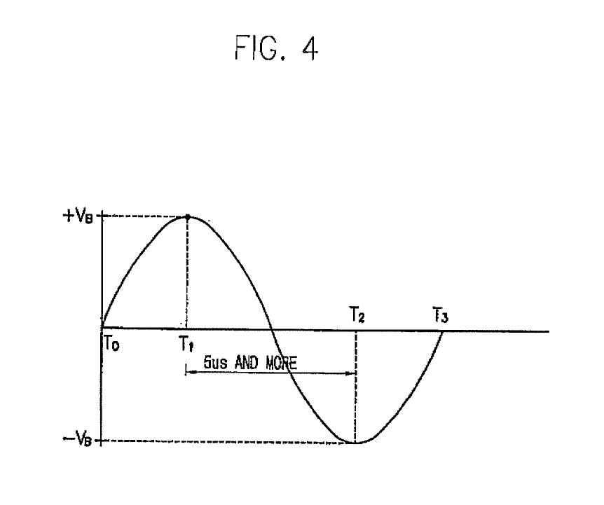

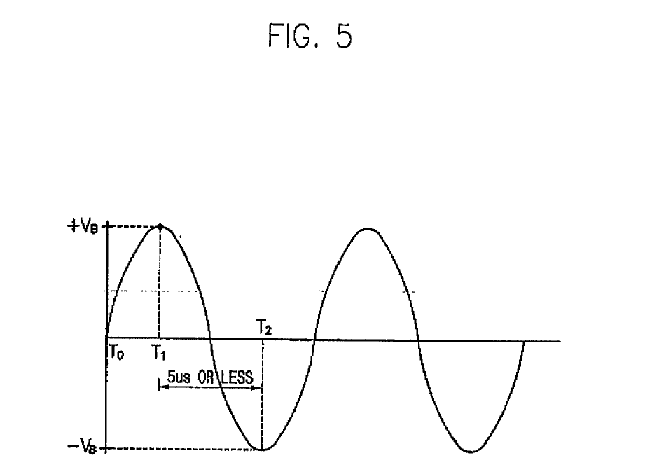

Generally, in order to drive a CCFT lamp, a sine wave alternating current (AC) power that swings between a positive maximum voltage (+V_{B}) and a negative maximum voltage (−V_{B}) with a predetermined period as shown in FIG. 4 is used.

However, it is difficult to anticipate an increase in the electron density since a polarity inversion time of this AC power, i.e., time arriving from the positive maximum voltage (+V_{B}) to the negative maximum voltage (−V_{B}), is longer than electron annihilation time, for instance, 5 μs (considering characteristics of the sine wave).

$$f = \frac{1}{\sqrt{{L}_{( secondary coil )} C}} \qquad Formula 3$$

To use a sine wave having a polarity inversion time shorter than the sine wave shown in FIG. 4 for the enhancement of the electron density, for example, having a polarity inversion time of 5 μs or less, increasing a driving frequency (f) shown in the above formula 3 is necessary. Thus, the secondary coil inductance (L _{secondary coil}) is lowered.

To do so, the windings of the secondary coil have to be decreased. Then, if the number of windings of the secondary coil is small, a desired driving voltage is not obtained.

Resultantly, according to formula 3, in order to increase the electron density for the purpose of lowering the power consumption, it is not possible to use a sine wave AC power typically used in driving a CCFT lamp.

To resolve these problems, the present invention discloses an AC power having a driving frequency corresponding to that of the sine wave and at the same time having a step pulse wave shorter than the driving frequency of the sine wave as one embodiment

If the step pulse wave is used, it becomes possible to maximize the internal electron density, thus operating the CCFT lamp at much lower driving voltage and thereby lowering the power consumption.

Various advantages such as decreased driving voltage and power consumption may be achieved. However, the use of the step pulse wave may cause an occurrence of a harmful electromagnetic wave due to a characteristic of the step pulse wave.

To resolve the problem, the present invention applies the step pulse wave within three seconds from a driving start time of the CCFT lamp. A sine pulse wave that has hardly any harmful electromagnetic wave is applied continuously to the CCFT lamp in succession. Resultantly, the invention resolves the harmful electromagnetic wave problem as well as the driving voltage and power consumption.

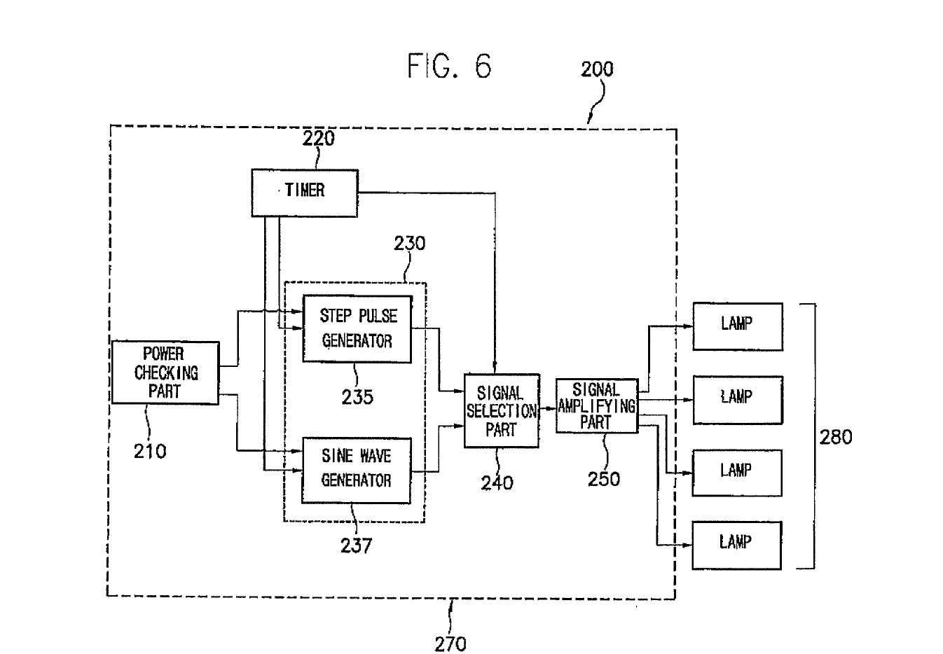

Hereinafter, constitution and operation of the CCFT illumination device capable of accomplishing various effects generated by controlling the electron stream within the CCFT lamp are described with reference to the accompanying drawing of FIG. 6.

As one embodiment of the present invention, a CCFT illumination device 200 includes an inverter 270 adopting the electron stream control way and a CCFT lamp 280. The inverter 270 applies an optimum driving power to the CCFT lamp 280.

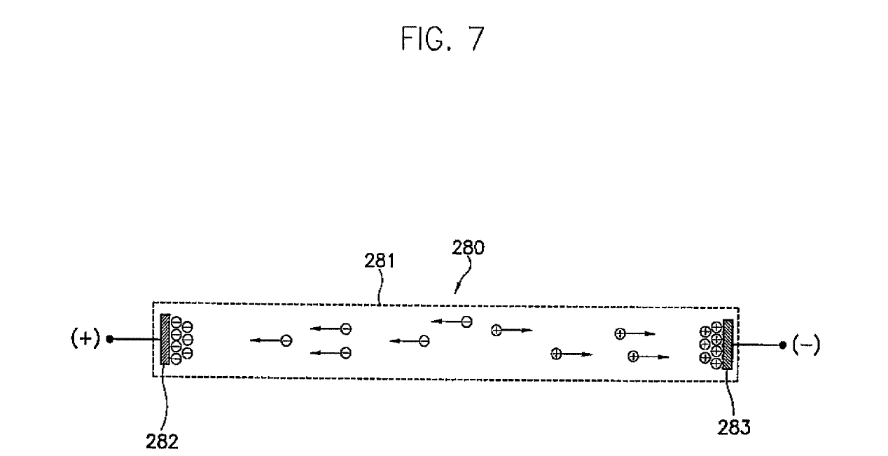

Specifically, referring to FIG. 7, the CCFT lamp 280 includes a lamp tube 281 and paired electrodes 282 and 283.

Specifically, the lamp tube 281 has a predetermined length and is comprised of transparent glass material. On the inner wall of the lamp tube 281, phosphorous material is coated. Electrodes 282 and 283 are disposed at respective both ends of the lamp tube 281. The lamp tube 281 also includes mercury vapor injected therein.

Meanwhile, to supply an optimum power such that the CCFT lamp 280 operates at low power consumption, the inverter 270 includes a power checking part 210, a timer 220, a waveform generating part 230, a signal selection part 240 and a signal amplifying part 250.

The power checking part 210 confirms whether external power is presently being applied to the inverter 270 and transfers the external power to the waveform generating part 230.

The waveform generating part 230 receives the external power input from the power checking part 210 and generates two kinds of waveforms. To generate two kinds of waveforms, the waveform generating part 230 consists of a step pulse generator 235 for generating a step pulse wave and a sine wave generator 237 for generating a sine wave.

More specifically, the step pulse generator 235 converts into a waveform of the step pulse a waveform of the external power supplied from the power checking part 210. The polarity inversion of the step pulse preferably is performed at least 5 μs.

Thus, as the step pulse is polarity-inverted within 5 μs, the electron density of the CCFT type lamp 280 is highly elevated compared with that of when the step pulse is polarity-inverted beyond 5 μs.

Meanwhile, the sine wave generator 237 converts into the sine wave the external power supplied from the power checking part 210. The sine wave renders the CCFT lamp 280 to start driving at a low voltage to operate stably without permitting any harmful electromagnetic wave to occur.

Thus, the step pulse generated from the step pulse generator 235 of the waveform generating part 230 is generated simultaneously with the driving start of the CCFT lamp 280, for example, within three seconds. The sine wave generated from the sine wave generator 237 of the waveform generating part 230 is applied to the CCFT lamp 280 directly after the elapse of the three seconds.

Thus, it is necessary to sort the applying timing of the two different kinds of waveforms. To this end, the timer 220 and a signal selection part 240 are used.

The signal selection part 240 selects either the step pulse generator 230 or the sine wave generator 237 and applies a selected waveform to the signal amplifying part 250. The selection of the signal selection part 240 is governed by a waveform selection signal applied from the timer 220.

Specifically, when an initial lamp turn-on signal is inputted from outside, the timer 220 applies a first signal to the signal amplifying part 250 for a selected time (for example, for three seconds). The signal selection part 240 receives a step pulse which corresponds to the first signal from the step pulse generator 235 and then applies the step pulse to the signal amplifying part 250.

Thereafter, if the selected time (such as three seconds) elapses, the timer 220 applies a second signal to the signal selection part 240. The signal selection part 240 receives a sine wave corresponding to the second signal from the sine wave generator 237 and applies the received sine wave to the signal amplifying part 250.

At this time, the signal amplifying part 250 that receives either the step pulse or sine wave raises the voltage of the step pulse or sine wave to a voltage level adapted for the driving of the CCFT lamp. For example, the signal amplifying part 250 may comprise a transformer.

Hereinafter, an operation of a CCFT illumination device having the above constitution is described with reference to the accompanying drawings.

As shown in FIG. 6, as a turn-on signal of the CCFT lamp is inputted from the outside, the external power is applied to the step pulse generator 235 and the sine wave generator 237 through the power checking part 210 shown in FIG. 6.

Thereafter, the timer 220 applies the first signal to the signal selection part 240. As the first signal is applied to the signal selection part 240, the step pulse generated from the step pulse generating part 235 is amplified through the signal amplifying part 250 and is then applied to the CCFT lamp 280.

Next, there is described an electron stream within the CCFT lamp to which a driving voltage elevated in the form of a step pulse is applied.

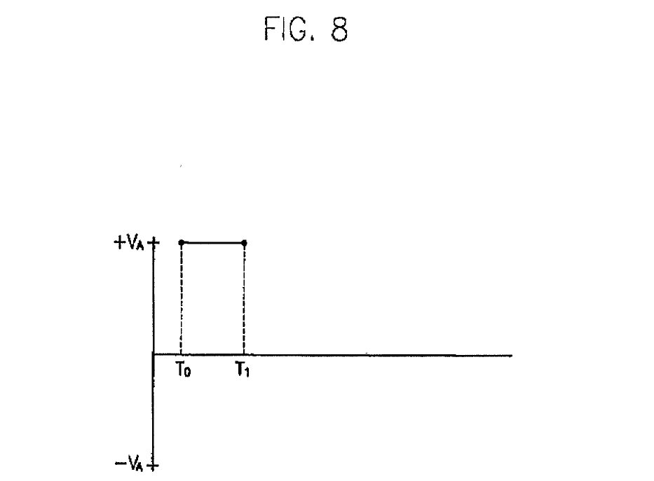

FIG. 7 is a schematic view showing a stream of electrons and ions within the CCFT lamp and FIG. 8 shows a high polarity of the waveform of the voltage-raised step pulse +V_{A} which is applied to an electrode 282 of the CCFT lamp of FIG. 7 which has the (+) polarity for a time T0-T1.

Referring to FIGS. 7 and 8, +V_{A} is a minimum driving voltage necessary for driving the CCFT lamp 280 and is obtained through the stream control of the electrons within the CCFT lamp 280 by the present invention. Therefore, the computed minimum driving voltage for the CCFT lamp of the invention is higher than the minimum driving voltage of the conventional CCFT lamp having a conventional inverter that does not use the stream control of the electrons within the CCFT lamp.

Thus, when the minimum driving voltage having a level of +V_{A} is applied to the CCFT lamp 280 during the time between T0 and T1, electrons generated from the CCFT lamp 280 are attracted toward the anode 282 having the positive polarity (+) and ions are attracted toward the cathode 283 having the negative polarity (−).

Thereafter, the attracted electrons collide with mercury atoms in the lamp 280 to thereby generate ultraviolet rays. The ultraviolet rays stimulate the fluorescent materials to thereby generate visible rays.

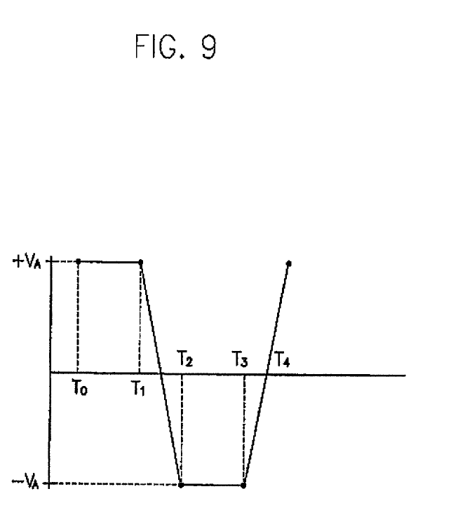

Thereafter, as shown in FIG. 9, the minimum driving voltage is polarity-inverted at an interval between T1 and T2 such that a high polarity interval of the step pulse has a size of −V_{A}.

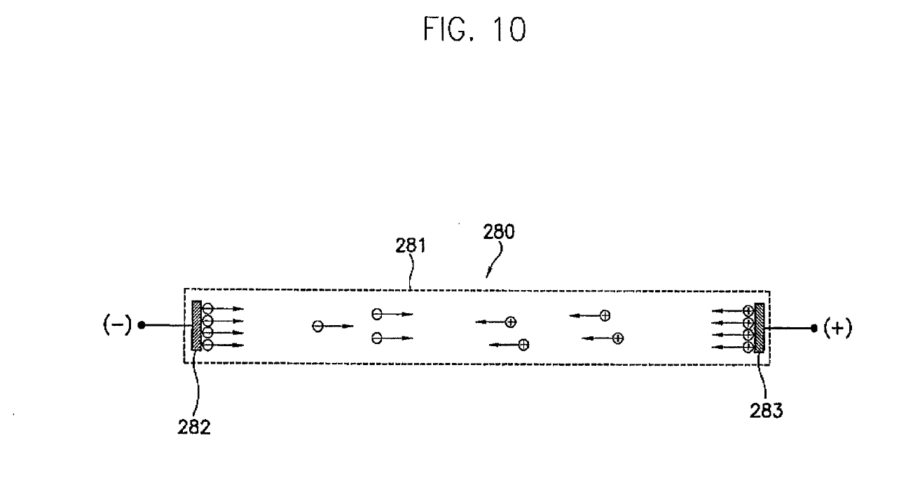

Referring to FIG. 10, the polarity inversion time at the interval between T1 and T2 preferably is within 5 μs of a time of when electrons generated from the negative polarity-inverted electrode 282 are annihilated by the positive electrode 283. Thus, the limited polarity inversion time allows some electrons not to be absorbed by the polarity-inverted electrode 282 having negative polarity, so that a total density of the electrons existing within the CCFT lamp 280 is increased.

Thereafter, the electrons generated from the negative electrode 282 move into the positive electrode 283 at an interval between T2 and T3, collide with the mercury atoms to generate ultraviolet rays and the visible rays stimulate the fluorescent particles to generate visible rays

Then, the minimum driving voltage −V_{A} having negative polarity is again polarity-inverted into the driving voltage +V_{A} having the positive polarity at an interval between T3 and T4. At this time, time spent in inverting the polarity of the driving voltage equals that spent in inverting the polarity of the driving voltage at the interval between T1 and T2.

Hereinafter, a step pulse generated at the interval between T0 and T4 is referred to as a “unit step pulse”. This unit step pulse is applied to the CCFT lamp 280 for a selected time, for example, three seconds.

Thus, the CCFT lamp 280 may be turned on by using the step pulse applied for the selected time.

However in the case that the CCFT lamp 280 is turned on or off only using the step pulse, a harmful electromagnetic wave can be generated from the CCFT lamp 280 depending on the characteristics of the step pulse.

To block off the harmful electromagnetic wave and at the same time lower the driving voltage, as one preferred embodiment of the invention, the timer 220 applies the second signal to the signal selection part 230 after the step pulse has been applied to the CCFT lamp 280 for a selected time as shown in FIG. 6. The sine wave generator 237 applies to the signal amplifying part 250 a sine wave having a voltage level of +V_{B} and which the polarity inversion time is longer than the electron annihilation time within the CCFT lamp 280. The signal amplifying part 250 amplifies the applied sine wave to a selected level and applies the amplified sine wave to the CCFT lamp 280.

Thus, the CCFT illumination device lowers the driving voltage and power consumption through the stream control of electrons and at the same time prevents the occurrence of a harmful electromagnetic wave. As a result, the CCFT illumination device can be used as light source in various fields such as a backlight assembly for an LCD, copier and scanner.

Recently, as LCD, scanner and copier sizes are being scaled up, the increased power consumption in the conventional CCFT illumination device has attracted attention. However, the CCFT illumination device provided by the present invention would resolve the power consumption problem.

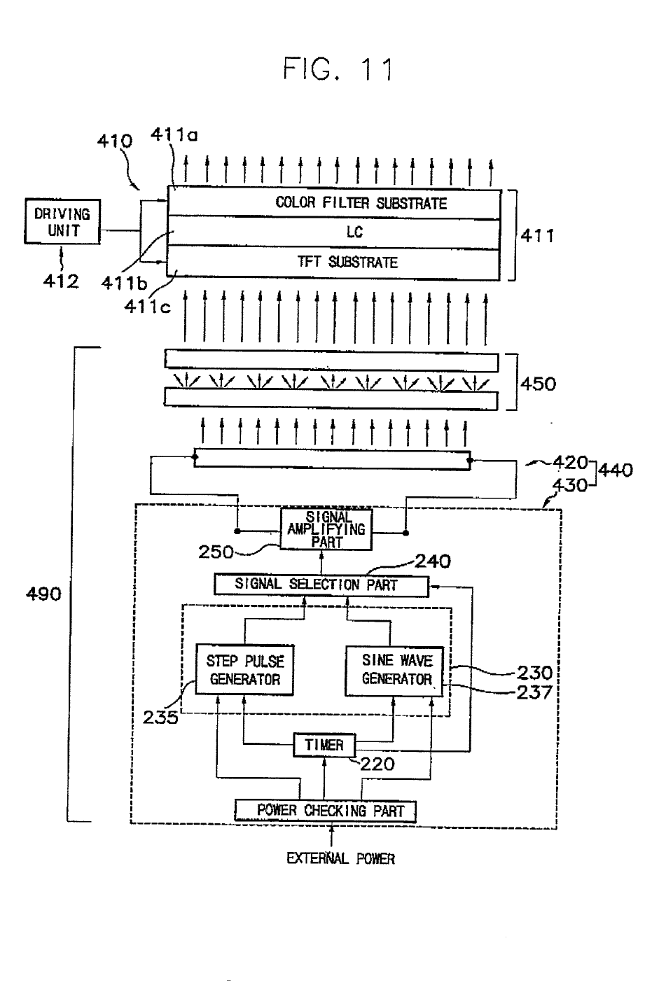

Next, an LCD having the aforementioned CCFT illumination device is described as another preferred embodiment of the present invention with reference to FIG. 11.

Referring to FIG. 11, an LCD 400 includes an LCD panel assembly 410 and a backlight assembly 490 as a whole.

The LCD panel assembly 410 includes an LCD panel 411, a flexible printed circuit (FPC) and an LCD panel driving unit 412.

The LCD panel 411 includes a color filter substrate 411a, a TFT substrate 411c and a liquid crystal layer 411b interposed between the color filter substrate 411a and the TFT substrate 411c.

Although not shown in the drawings, the TFT substrate 411c includes a glass substrate, a thin film transistor (TFT), a gate line, a data line and a pixel electrode.

For instance, when the LCD has a resolution of 800×600, thin film transistors having a number of 800×600×3 are arranged in a matrix configuration on the glass substrate. The thin film transistors are generally formed using a thin film process for forming semiconductor devices.

Here, gate electrodes of TFTs are commonly connected to gate line arranged along the row direction for forming the TFTs. Also, source electrodes of the TFTs are commonly connected to data lines arranged along the column direction. Pixel electrodes of Indium Tin Oxide (ITO) are connected one-to-one to drain electrodes of the TFTs.

The color filter substrate 411a includes color filters of R, G, B formed facing the pixel electrodes of the TFT substrate 411c using a thin film process for forming semiconductor devices. On the entire surface of the color filters, a common electrode of ITO is formed.

The TFT substrate 411c and the color filter substrate 411a are assembled interposing the liquid crystal layer 411b therebetween after the pixel electrodes of the TFT substrate 411c are precisely aligned with the color filters of the color filter substrate 411a. The liquid crystal layer 411b is formed to a thickness of a few μm by injecting liquid crystal into a space between the TFT substrate 411c and the color filter substrate 411a and sealing an inlet for introducing the liquid crystal.

After that, a gate printed circuit board (PCB) is established a certain distance apart from one edge of the TFT substrate 411c using a gate FPC as an interconnection medium, and a data PCB is established a certain distance apart from another edge of the TFT substrate 411c using a source FPC as an interconnection medium.

To display a picture on the LCD panel 411, when an electrical signal is applied to respective data lines of the LCD assembly 410, a gate turn-on signal is applied to a first gate line. As a result, electric potential between the pixel electrodes and the common electrode is varied and thus the alignment of the liquid crystal molecules is changed.

As the alignment of the liquid crystal molecules is changed, incident light passes the pixel electrode, the liquid crystal and the color filters of R, G, B sequentially and then is incident into the eye of a user.

After that, when electrical signals corresponding to a video signal are sequentially applied to the data lines, a next gate line is selected, a turn-on signal is applied to the gate electrode, and an electric potential between the corresponding pixel electrode and the common electrode is varied. Thus the alignment of the liquid crystal molecules is changed. The above procedures are sequentially repeated line-by-line.

In addition to operating an LCD assembly as above, to display a picture, it is also taken into account that the liquid crystal is a light-receiving device, which means that a picture cannot be displayed only with the alignment of the liquid crystal molecules without an external light source. To this end, the backlight assembly 490 is provided below the LCD panel assembly 410 to supply light beams onto the LCD panel assembly.

The backlight assembly 490 includes a CCFT illumination device 440, a light diffusion member 450 for uniformly diffusing the light beams generated from the CCFT illumination device 440 and a receiving container for housing the CCFT illumination device 440 and the light diffusion member 450.

The CCFT illumination device 440 includes a CCFT lamp 420 and an inverter 430 for controlling the electron stream. The inverter 430 is described above, with regard to the discussion of inverter 270 in FIG. 6.

In the case that the inverter 430 is adapted for the LCD, although the CCFT lamp 420 is lengthened, the inverter 430 restrains an increase of the power consumption followed by the elevation of the driving voltage to the highest degree. This means that it is possible to decrease the power consumption although the length of the CCFT lamp 420 proportional to the display area of the LCD panel 411 increases.

To accomplish the power consumption, the timer 220 of the inverter 430 applies the first signal to the signal selection part 230, thereby allowing a step pulse to be selected from the step pulse generator 235. The polarity inversion time of the step pulse 235 is shorter than the time spent when electrons move from and are annihilated at the other electrode.

After that, selected step pulse is amplified at the signal amplifying part 250 and then is applied to the CCFT lamp 420.

For instance, when a driving voltage when using an AC signal with the polarity inversion time longer than the electron annihilation time is called a Vₑ and a driving voltage when using an AC signal with the inversion time shorter than the electron annihilation time is called a Vₜ, the power consumption of Vₑ is greater than the power consumption of Vₜ.

This relationship means that it is possible to fabricate a much longer CCFT lamp under a constant driving voltage by driving the same kinds of at least two CCFT type lamps depending on different driving methods and to lower the power consumption to a large degree although the two lamps have the same length.

As described previously, although the CCFT lamp is lengthened the present invention prevents increased power consumption to a large degree by changing the driving method.

Also, the present invention allows fabricating a longer CCFT lamp.

Furthermore, in spite of the increased length of the CCFT lamp, the present invention decreases the driving voltage and the power consumption and minimizes the occurrence of harmful electromagnetic waves.

Moreover, the present invention lengthens the time to arrive at discharge from the charged state of the battery when it is adapted for LCDs needing an artificial light source.

While the present invention has been described in detail, it should be understood that various changes, substitutions can be made hereto without departing from the spirit and scope of the invention as defined by the appended claims.

What is claimed is:

1. A method for controlling a stream of electrons within a CCFT lamp, the method comprising the steps of:
i) applying a first driving voltage having a first polarity between a first electrode and a second electrode facing the first electrode, the first and second electrodes being formed within a tube of the CCFT lamp such that a potential difference is generated between the first electrode and the second electrode;
ii) inverting polarity of the first and second electrodes within an electron annihilation time when electrons within the tube move from the first electrode to the second electrode and are annihilated; and
iii) applying a second driving voltage having a second polarity opposite to the first polarity between the polarity-inverted first electrode and the polarity-inverted second electrode.

2. The method of claim 1, wherein time spent in inverting the polarity of the first and second electrodes in said step ii) is within 5 μs.

3. The method of claim 1, wherein a wave formed for performing steps i) to iii) is a step pulse wave.

4. A method for driving a CCFT illumination device, the method comprising the steps of:
generating a first driving voltage swinging with a predetermined polarity inversion time;
elevating the first driving voltage up to a second driving voltage having a level higher than the first driving voltage, the second driving voltage having a minimum voltage level for generating an electron stream; and
applying the second driving voltage to the CCFT lamp.

5. The method of claim 4, wherein the polarity inversion time is an electron annihilation time spent until the electrons move from the first electrode into the second electrode and are annihilated.

6. The method of claim 5, wherein the polarity inversion time is within 5 μs.

7. A method for driving a CCFT illumination device, the method comprising the steps of:
i) generating a step pulse wave which swings with a reference voltage and a first polarity inversion time and a swing wave which swings with a second polarity inversion time longer than the first polarity inversion time;
ii) selecting the step pulse wave to elevate the reference voltage step pulse wave up to a first voltage which is a minimum voltage level necessary for generating a stream of electrons within the CCFT lamp and then applying the first voltage to the lamp for a predetermined time; and
iii) selecting the sine wave to elevate the reference voltage up to a second voltage which is a minimum voltage level necessary for generating the stream of the electrons within the CCFT lamp and then applying the second voltage to the lamp for a predetermined time.

8. The method of claim 7, wherein the predetermined time of each of steps (ii) and (iii) is within 3 seconds.

9. The method of claim 8, wherein the predetermined time is computed by a time measuring means.

10. The method of claim 7, wherein the selecting of the step pulse wave or the sine wave is performed by a signal selection part.

11. The method of claim 7, wherein electron movement is between a first electrode and a second electrode, and the first polarity inversion time is within an electron annihilation time spent until the electrons move from one electrode to the other electrode and are annihilated.

12. The method of claim 11, wherein the first polarity inversion time is 5 μs or less.

13. A CCFT illumination device comprising:
a CCFT lamp including a CCFT lamp tube having a cylindrical shape of a predetermined length, a first electrode formed at a first end of the lamp tube and a second electrode formed at a second end facing the first end;
a waveform generating part for generating a first voltage having a waveform of which the polarity is inverted within a time shorter than an electron annihilation time spent until electrons within the lamp tube move from the first electrode to the second electrode and are annihilated; and
means for elevating the first voltage up to a minimum second voltage necessary for generating a stream of the electrons and applying the second voltage to the CCFT lamp.

14. The illumination device of claim 13, wherein the waveform generated from the waveform generating part is a step pulse wave and the polarity inversion time of the step pulse wave is within 5 μs.

15. A CCFT illumination device comprising:
a CCFT lamp including a CCFT lamp tube having a cylindrical shape of a predetermined length, a first electrode formed at a first end of the lamp tube and a second electrode formed at a second end facing the first end;
a step pulse waveform generating part for generating a step pulse waveform which swings with a first reference voltage and a first polarity inversion time;
a sine wave generating part for generating a sine wave which swings with the reference voltage and a second polarity inversion time longer than the first polarity inversion time;
a signal selection part for selecting the step pulse waveform or the sine wave;
means for determining a waveform applying timing which the signal selection part selects for the step pulse waveform or the sine wave; and
means for amplifying either the step pulse waveform or the sine wave to a predetermined level.

16. The illumination device of claim 15, wherein the waveform applying timing determining means first selects the step pulse waveform for a predetermined time and then selects the sine wave.

17. The illumination device of claim 16, wherein the predetermined time is within 3 seconds and the polarity inversion time is 5 μs.

18. An LCD comprising:
an LCD panel assembly which controls an alignment of liquid crystal molecules in response to an input video signal to display a picture; and
a backlight assembly including a CCFT lamp, a pulse generating part for generating either a first signal of a step pulse waveform or a second signal of a sine waveform, a signal selection part selecting either the first signal or the second signal, a module for determining a waveform applying timing which the signal selection part selects for the step pulse waveform or the sine wave, an inverter having a signal amplifying part for amplifying the first signal or the second signal as selected to a certain level to apply the amplified signal to the CCFT lamp, and means for diffusing light beams generated from the CCFT type lamp.
